(19) United States
(12) Patent Application Publication
(10) Pub. No.: US 2015/0127702 A1
(43) Pub. Date: May 7, 2015

(54) Method for the Transmission of Messages in a Computer Network and Computer Network

(71) Applicant: FTS Computertechnik GmbH, Wien (AT)

(72) Inventors: Wilfried Steiner, Vienna (AT); Wolfgang Forster, Zellerndorf (AT)

(73) Assignee: FTS Computertechnik GmbH

(21) Appl. No.: 14/524,991

(22) Filed: Oct. 27, 2014

(30) Foreign Application Priority Data
Nov. 7, 2013 (AT) A50746/2013

(51) Int. Cl. H04L 29/08

(52) U.S. Cl. CPC H04L 67/10
USPC 709/201

(57) ABSTRACT

The invention pertains to a method for the transmission of messages in a computer network, wherein the computer network comprises computing nodes with said computing nodes being interconnected by means of at least one star coupler and/or at least one multi-hop network, wherein each computing node is connected to the at least one star coupler via at least one communication line, and wherein the computing nodes exchange Ethernet messages among each other and with the at least one star coupler and/or the at least one multi-hop network, and wherein at least a portion, e.g. one, two, multiple or all Ethernet messages are communicated in a time-controlled manner, and wherein at least one star coupler implements at least one function (COF); the at least one function (COF) is characterized by using one, two or multiple time-controlled Ethernet messages and/or parts of one, two or multiple Ethernet messages as input parameter(s), and generating one, two or multiple Ethernet messages or parts of one, two or multiple Ethernet messages as output; and the time use of the function (COF) is for at least a portion, for example for one, two, multiple or all time-controlled communicated Ethernet messages and/or its multiple implementation in the star coupler linked to the communication schedule of the time-controlled Ethernet messages, so that the time use of the function (COF) and/or its multiple implementation is at least partially predefined by the communication schedule of the time-controlled messages.

### CROSS-REFERENCE TO RELATED APPLICATIONS

The present application claims priority to Austrian Patent Application No. A50746/2013 filed on Nov. 7, 2013, the disclosures of which are incorporated herein by reference in their entirety.

The invention pertains to a method for the transmission of messages in a computer network, wherein the computer network comprises computing nodes, with said computing nodes being interconnected by means of at least one star coupler and/or at least one multi-hop network, wherein each computing node is linked by means of a communication line to the at least one star coupler and/or the at least one multi-hop network, and wherein the computing nodes exchange Ethernet messages among each other and with the at least one star coupler and/or the at least one multi-hop network.

The invention further pertains to a computer network for the transmission of messages in a computer network, wherein the computer network comprises computing nodes, with said computing nodes being interconnected by means of at least one star coupler and/or at least one multi-hop network, wherein each computing node is linked by means of a communication line to the at least one star coupler and/or the at least one multi-hop network, and wherein the computing nodes exchange Ethernet messages among each other and with the at least one star coupler and/or the at least one multi-hop network.

The present invention applies to the field of computer technology. It describes an innovative method and supporting hardware for the cost-effective implementation of computing functions, in particular complicated mathematical functions, such as cryptographic functions, in star couplers.

The invention applies to the field of distributed real-time systems, wherein such real-time system consists of two types of active components: computing nodes and star couplers. Computing nodes execute functions such as the measuring of properties of physical processes by means of suitable sensors, the calculation of control variables, or the activation of actuators, such as valves. Computing nodes are connected to other computing nodes and/or star couplers, preferably by means of bi-directional lines. Furthermore, star couplers may be connected to each other by bi-directional lines as well. The exchange of information between components is message-based, and in the following description, we assume that the exchange of information uses Ethernet messages. Messages may have different identities, and all messages with the same identity create a “message flow”.

In such a real-time system, time-controlled communication can be implemented in that the computing nodes and the star couplers synchronize their respective local clocks to a common time base and send the messages according to a set time schedule (the so-called communication schedule) according to the common time base. Messages that are sent in such a way are called time-controlled messages. The communication schedule is typically created in such a way that the time-controlled messages are transported through the network with a duration that is as short as possible and as constant as possible.

One example of an Ethernet-based real-time system that implements time-controlled communication is the TTEthernet protocol. The TTEthernet protocol according to standard SAE AS6802 uses the term “end system” as a synonym for computing nodes and “Switch” as a synonym for star coupler. Furthermore, in TTEthernet all messages communicated between computing nodes and star couplers, are Ethernet messages.

The creation and processing of the contents of the Ethernet messages being communicated in the computer network, may require functions, typically computational functions, in particular CPU-intensive COF functions in the star coupler(s). One example of a CPU-intensive function in a star coupler is a cryptographic procedure, such as described in IEEE 802.1AE and the Advanced Encryption Standard (AES). When applying said standards, it may be necessary for an Ethernet message being received by a star coupler and containing encrypted data to be newly encrypted again with an alternate key. This type of cryptographic handling of Ethernet messages and/or their contents is CPU-intensive and can, for example, imply the following costs in the star coupler: large silicon surface, high forwarding latency of messages, high energy consumption.

A star coupler which receives and forwards Ethernet messages is—or should furthermore be—generally designed such that multiple Ethernet messages are forced to use the CPU-intensive function simultaneously or at overlapping times since in a star coupler, Ethernet messages are usually received at same times from multiple computing nodes (and/or other star couplers) and must be forwarded. This leads to the fact that either (a) the CPU-intensive functions must be implemented into the star coupler multiple times, or (b) the total number of Ethernet messages in the computer network must be significantly reduced (e.g. a 1 Gbps Ethernet network can be utilized to a capacity of 1 Mbps only), or (c) Ethernet messages are delayed in the star coupler significantly longer, due to holding effects, or (d) Ethernet messages get lost.

One objective of the present invention is the provision of a cost effective solution to this problem. In addition, the present invention serves to increase the determinism in a distributed real-time system so that the system can be better planned, verified, validated and certified.

This objective is achieved with an above-mentioned method as well as an above-mentioned computer network, in that according to the invention

a) at least a portion, e.g. one, two, multiple or all, of the Ethernet messages are communicated in a time-controlled manner, and

b) at least one star coupler implements at least one function, wherein the said at least one function is characterized by using one, two or multiple time-controlled Ethernet messages and/or parts of one, two or multiple Ethernet messages as input parameters, and by generating as output one, two or more Ethernet messages and/or parts of one, two or multiple Ethernet messages, and

c) for at least a portion, e.g. for one, two, multiple or all of the communicated time-controlled Ethernet messages, the temporal utilization of the function and/or its multiple implementation in the star coupler is linked to communication schedule of the time-controlled messages, so that the temporal use of the function and/or its multiple implementation is, at least partially, dictated by the communication schedule of the time-controlled messages.

The components may be computing nodes, other star couplers and multi-hop networks.

The term “implement” and/or “a device implements a function” means that the device enables this function to run, i.e. the matching program for the function to run is available in the device, meaning that it has this program stored and is able to access it. The function=the program may a) therefore be stored in the star coupler or b) the function=the program is executed in the star coupler.

“Multiple implementation of the function” means that the function may be present in the star coupler multiple times, and accordingly able to run multiple times in the star coupler.

The invention solves the problem described above by linking the internal use of the computing functions, especially the CPU-intensive functions of a star coupler, to the communication schedule of the time-controlled communication. That is, the communication schedule is selected for optimum use of the available computational functions, particularly CPU-intensive functions in the star coupler.

Preferred embodiments of the method according to the invention and of the computer network according to the invention, which may be implemented alone or together in any combination, are described in the following:

*) A star coupler implements a number of functionally equivalent functions, where this number is smaller than the number of the components to which the star coupler can be connected directly at the same time. A star coupler has a maximum number of ports able to be connected to components. Depending on the application, it may happen that not all ports of the star coupler are connected to components. This means that an application may use an 8-port star coupler, but connect only 4 of the 8 ports to components, although a connection to 8 ports would be possible;

*) for reasons of fault tolerance, function may be implemented differently while having the same functionality. These functions are therefore functionally equivalent but not identical. It may, however, also be provided for functionally equivalent functions to be identical functions;

*) The link of the communication schedule to the utilization of the function and/or its multiple implementation in the star coupler is designed such that one or more of the following conditions apply:

a) at no time may more Ethernet messages or parts of these Ethernet messages be delivered to the function or be already processed by the function than the function is able to process simultaneously;

b) the times of transmission and/or forwarding and/or arrival of Ethernet messages, which can be defined in the communication schedule, are selected such that the space of time between the arrival of a time-controlled Ethernet message in a star coupler and its processing by the function does not exceed a given duration;

c) the times of transmission and/or forwarding and/or arrival of Ethernet messages, which can be defined in the communication schedule, are selected such that the space of time between the arrival of a time-controlled Ethernet message in a star coupler and its processing by the function does not fall below a given duration;

*) A star coupler may, in addition to the number of functionally equivalent, in particular identical, COF functions, in particular functionally equivalent CPU-intensive functions, for example, identical CPU-intensive functions, which are used for time-controlled Ethernet messages or parts of the Ethernet messages, also implement one, two or multiples of these functions, which can be used by non-time-controlled Ethernet messages;

*) The at least one or two or multiple functions (COF) is a function or are functions, which encrypts or encrypt the content of at least part of the time-controlled messages being used as input parameter(s) according to a cryptographic algorithm;

*) The at least one or two or multiple functions (COF) is a function or are functions, which decrypts or decrypt the content of at least part of the time-controlled messages being used as input parameter(s) according to a cryptographic algorithm;

*) The at least one or two or multiple functions (COF) is a function or are functions, which packages or package the content of one, two or multiple time-controlled Ethernet messages into one, two or multiple new Ethernet messages, where the new Ethernet messages, preferably, are not identical to the original Ethernet messages;

*) In a star coupler, the routing (s) from/to the function or its multiple implementations and/or the processing of the Ethernet messages or parts of the Ethernet messages in the function is activated by the common time base reaching predetermined values;

*) The one or two or multiple Ethernet messages generated by the function (COF) are not identical to the Ethernet message(s) being used as input parameters to generate the at least one Ethernet message.

In the following, the invention is discussed in greater detail in reference to the drawing based on one exemplary embodiment. It shows:

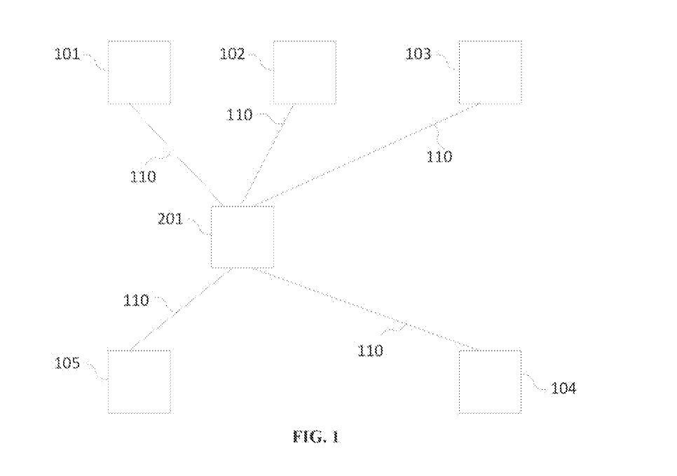

FIG. 1 an example of an Ethernet network implementing time-controlled communication, in which computing nodes are connected to a star coupler by means of bi-directional communication lines,

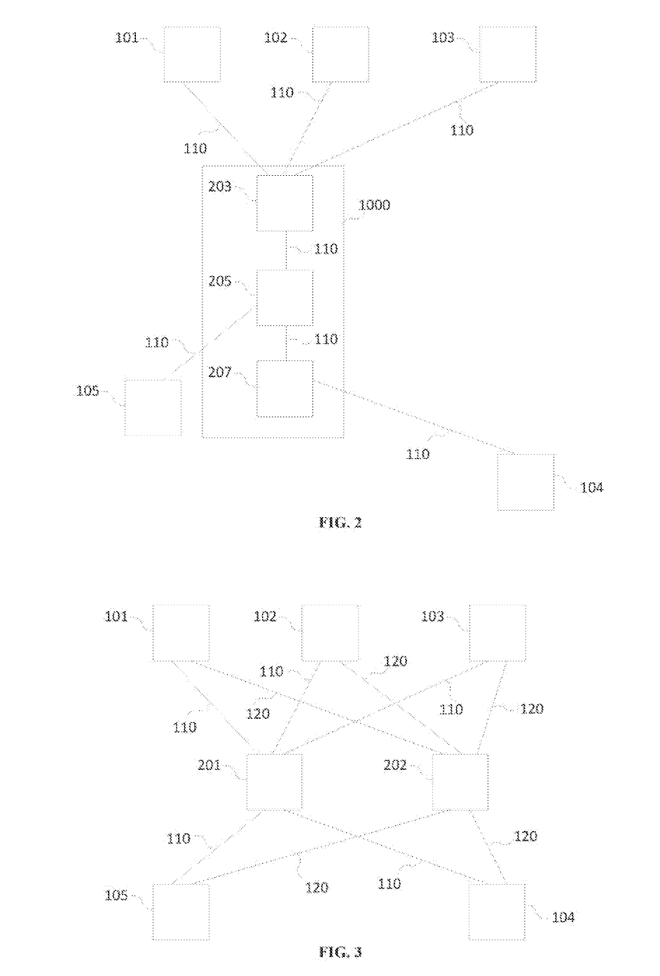

FIG. 2 another example of an Ethernet network,

FIG. 3 an example of an Ethernet network implementing time-controlled communication, in which the computing nodes are connected to redundant star couplers by means of bi-directional communication lines,

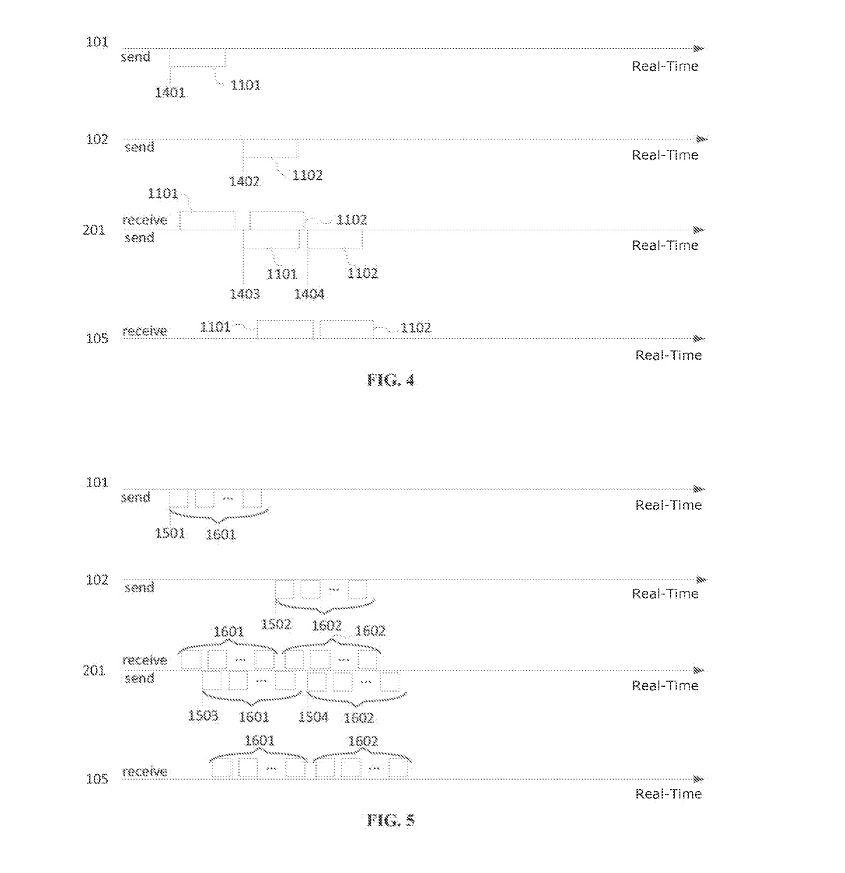

FIG. 4 a diagram illustrating time-controlled communication,

FIG. 5 an additional exemplary diagram illustrating time-controlled communication

FIG. 6 a part of the internal structure of a star coupler,

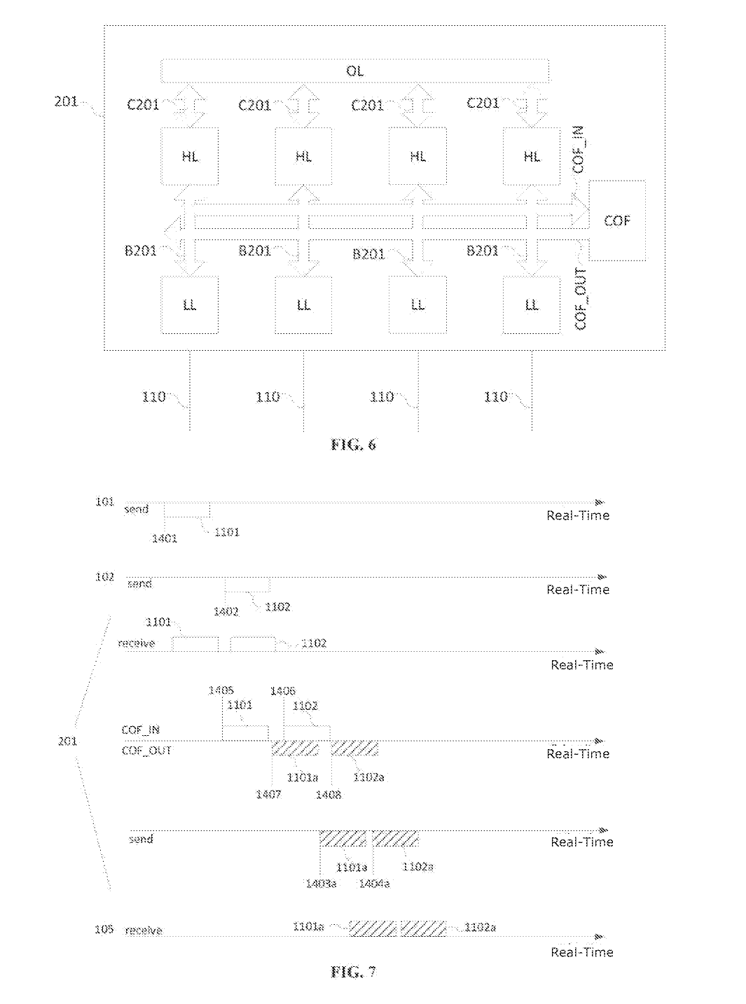

FIG. 7 an exemplary communication scenario in which a star coupler implements a CPU-intensive function,

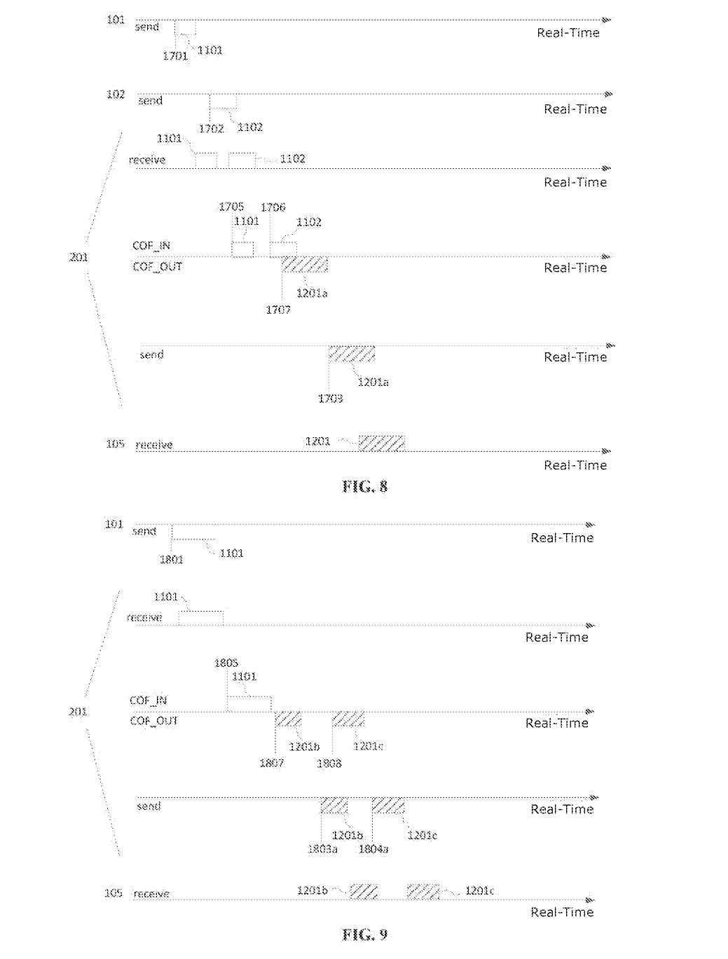

FIG. 8 an example of a communication scenario in which the COF function accepts two Ethernet messages as input, from which it generates one single Ethernet message, and

FIG. 9 an example of a communication scenario in which the COF function accepts one Ethernet message as input, from which it generates two Ethernet messages.

FIG. 1 shows an example of an Ethernet network in which computing nodes 101-105 are connected by means of bidirectional communication lines 110 to a star coupler 201. The computing nodes 101-105 exchange Ethernet messages with each other by sending them to the star coupler 201, and by the star coupler forwarding the messages to the appropriate recipient. Furthermore, a star coupler 201 itself may also generate Ethernet messages and send them to computing nodes 101-105.

FIG. 2 shows that a plurality of star couplers 201 may be connected to each other as well, and that computing nodes 101-105 are connected to a subset of these star couplers 203, 205, 207 only. The communication between two computing nodes can then take place by means of two or more star couplers 203, 205, 207. Such network structures are called multi-hop networks 1000. The following description does not explicitly discuss multi-hop networks, however, prior art states that individual star couplers 201 (FIG. 1) can be replaced by a multi-hop network 1000 (FIG. 2).

FIG. 3 shows an example of an Ethernet network in which computing nodes 101-105 are connected by means of redundant bi-directional communication lines 110, 120 to redundant star couplers 201, 202. Computing nodes can now communicate by means of star couplers 201, 202 with each other, including simultaneously. This means that the redundancy in the network tolerates the failure of individual components. If, for example, computing node 101 wants to communicate with computing node 102, it is able to send messages to star coupler 201 as well as to star coupler 202. In the error-free case, both star couplers 201 and 202 then route the messages to computing node 102. If, however, one of the two star couplers 201 or 202 is faulty, it has been made sure that the respective non-faulty star coupler 201 or 202 will reliably route the messages from computing node 101 to computing node 202.

FIG. 4 is an exemplary flow diagram illustrating time-controlled communication. In the example, computing nodes 101 and 102, as shown in FIG. 1, transmit time-controlled messages 1101 and 1102 by means of the star coupler 201 to the computing node 105. The unique characteristic of time-controlled communication is the fact that the moment of transmission 1401, 1402 and/or the routing moments 1403, 1404 of the time-controlled messages are known already before the message is sent. The transmission times 1401, 1402 and/or the routing time points 1403, 1404 may, for example, be defined already during the design of the distributed real-time system. The definition of the moments of transmission, routing/forwarding, receiving times or a subset thereof is called the communication schedule.

FIG. 5 represents another example where time-controlled communication is illustrated in a flow diagram. In FIG. 5, different from FIG. 4, groups 1601, 1602 of time-controlled messages are matched to one transmission time 1501, 1502 and one routing time 1503, 1504. As shown in FIG. 5, the correlation of the message to the group 1601, 1602 remains. This is not necessarily the case—the star coupler 201, for example, could implement the routing/forwarding point in time only and, when the routing/forwarding point in time has been reached, forward all messages of groups 1601 and 1602. In general, the assignment of a message to a group of computing nodes can be reconfigured in any particular way.

FIG. 6 represents an exemplary section of the internal structure of a star coupler 201. The star coupler 201 is connected by means of communication lines 110 to computing nodes or other star couplers, receives Ethernet messages via theses communication lines 110, and forwards Ethernet messages received on these communication lines 110. Furthermore, the star coupler 201 itself is also able to generate Ethernet messages, which it then sends via the communication lines 110. FIG. 6 shows an example of four communication lines 110 being used by the star coupler 201 to communicate. For reasons of simplification, no distinction is made in the following description between individual data within an Ethernet message and an Ethernet message as a whole; instead, it describes the case, in which each complete Ethernet message is processed. The described principles are also directly applicable when only portions of the Ethernet message are processed.

Based on the exemplary number of communication lines 110, the star coupler 201 in FIG. 6 implements, by way of example, per communication line 110 one lower communication layer LL and one upper communication layer HL, wherein the lower communication layer LL exchanges Ethernet messages (or parts of the Ethernet messages) with the upper communication layer HL via an interface B201. Also represented is a higher-level layer OL which accepts the Ethernet messages (or parts thereof) from the upper communication layer HL via an interface C201 and forwards them, so that overall Ethernet messages received from a communication line 110 will be forwarded to communication lines 110.

Furthermore represented in FIG. 6 is a computing function, in particular a CPU-intensive COF function, for example, a function for the purpose of the decryption and/or encryption of data. As shown, the CPU-intensive COF function is implemented in the star coupler 201 exactly once but may also be implemented more than once.

Ethernet messages (or parts thereof) received from the communication lines 110 may, for example, be sent by the lower communication layers LL via an information channel COF_IN to the CPU-intensive COF function, which will then use these Ethernet messages (or parts thereof) as input parameter(s). The CPU-intensive COF function processes the Ethernet message and delivers the modified Ethernet message via an information channel COF_OUT to the upper communication layers HL. The upper communication layers HL then deliver the modified Ethernet message (or parts thereof) to the higher-level communication layer OL.

Ethernet messages (or parts thereof) to be sent may be transmitted from the upper communication layers HL via the information channel COF_IN to the CPU-intensive COF function, which then uses them as input parameters. The CPU-intensive COF function modifies the Ethernet message or parts thereof and sends the modified Ethernet message (or parts thereof) to the lower communication layers LL.

The points in time at which the Ethernet messages (or parts thereof) are sent from the communication layers HL, LL and the COF function or its multiple implementation and/or the points in time at which the COF function processes the Ethernet messages (or parts thereof) and issues them to the respective communication layers HL, LL, are thus determined by the communication schedule. Moreover, it is possible to activate the redirects and/or the processing of the Ethernet messages (or parts thereof) directly by the common time base. This means, to give an example, that the COF function is not executed purely based on the fact that Ethernet messages (or parts thereof) are available as input, but due to the fact that the common time base has also reached a predefined point in time.

FIG. 7 shows, as an example, a communication scenario, in which the star coupler 201 implements a CPU-intensive COF function. The star coupler 201 receives time-controlled messages 1101, 1102 from computing nodes 101 and 102, which are sent by the computing nodes at the respective times 1401 and 1402. As shown, the Ethernet messages are received by the star coupler 201 and, prior to being forwarded, sent to the CPU-intensive COF function, at the given times 1405 and 1406. The CPU-intensive COF function modifies the Ethernet messages 1101, 1102 (or parts thereof) and makes the modified Ethernet messages 1101a, 1102a (or parts thereof) available at the information channel COF_OUT. The modified Ethernet messages 1101a, 1102a are subsequently sent to computing node 105 at times 1403a and 1404 via the communication line 110.

As can be seen in FIG. 7, the points in time at which the CPU-intensive COF function receives the Ethernet messages, are linked to the points in time of the communication schedule (i.e. the times of transmission of messages 1401, 1402). The invention utilizes this link in order to minimize the number of same CPU-intensive COF functions being implemented in a star coupler 201. In FIG. 7, this link is such that one CPU-intensive COF function is sufficient, since the communication schedule has been selected such that at any time only exactly one Ethernet message (or a part thereof) must be handled by the CPU-intensive COF function.

Generally, the link between the use of the CPU-intensive COF function and the communication schedule forces conditions that must be met by the communication schedule. Examples of such conditions are the following:

a) At no time shall more Ethernet messages (or parts of the messages) be delivered to the CPU-intensive COF function or already processed by the COF than the CPU-intensive function is able to process simultaneously,

b) the times of transmission and/or forwarding and/or receiving of Ethernet messages having to be defined in the communication schedule must be chosen such that the time from the receiving of a time-controlled Ethernet message in a star coupler 201 until its processing 1405, 1406 by the CPU-intensive COF function does not exceed a predefined duration,

c) the times of transmission and/or forwarding and/or receiving of Ethernet messages having to be defined in the communication schedule must be chosen such that the time from the receiving of a time-controlled Ethernet message in a star coupler 201 until its processing 1405, 1406 by the CPU-intensive COF function does not fall below a predefined duration.

FIG. 8 represents an exemplary communication scenario in which the COF function accepts two Ethernet messages 1101 and 1102 as input, and generates one single message 1201a from the two Ethernet messages 1101 and 1102. The times 1701, 1702 of the sending the messages 1101, 1102 and the times of the forwarding of 1705 and 1706 (via information channel COF_IN) to the COF function as well as the issuance 1707 of the generated Ethernet message 1201a via information channel COF_OUT of the COF function are determined by the communication schedule. Furthermore, the time 1703 of the forwarding of the message 1201a to the computing node 105 may also be determined by the communication schedule.

FIG. 9 shows an exemplary communication scenario in which the COF function accepts a single Ethernet message 1101 as input and generates two Ethernet messages 1201b and 1201c from this single Ethernet message 1101. The times of the sending of the message 1801 and the forwarding 1805 (via information channel COF_IN) to the COF function and the output 1807, 1808 via information channel COF_OUT of the COF function are determined by the communication schedule. Furthermore, the times 1803a and 1804a of the forwarding of the messages 1201b and 1201c to the computing node 105 may also be determined by the communication schedule.

What is claimed:

1. A method for the transmission of messages in a computer network, wherein said computer network comprises computing nodes, with said computing nodes-being interconnected via at least one star coupler and/or at least one multi-hop network, where each computing node-is linked via at least one communication line to the at least one star coupler and/or the at least one multi-hop network, and where the computing nodes exchange Ethernet messages among each other and with the at least one star coupler and/or the at least one multi-hop network
characterized in that
a) at least a portion, e.g. one, two, multiple or all, of the Ethernet messages are communicated in a time-controlled manner, and
b) at least one star coupler implements at least one function (COF), with the at least one function (COF) being characterized in that it uses one, two or multiple time-controlled Ethernet messages and/or parts of one, two or multiple Ethernet messages as input parameter(s), and that it generates as output one, two or more Ethernet messages and/or parts of one, two or multiple Ethernet messages, and
c) for at least a portion, e.g. for one, two, multiple or all, of the time-controlled communicated Ethernet messages the time of use of the function (COF) and/or its multiple implementation in the star coupler is linked to the communication schedule of the time-controlled messages, so that the time use of the function (COF) and/or its multiple implementation is at least partially predetermined by the communication schedule of the time-controlled messages.

2. The method according to claim 1 characterized in that a star coupler implements a number of functionally equivalent functions (COF), said number being smaller than the number of components, to which this star coupler can be directly connected at the same time.

3. The method according to claim 2 characterized in that functionally equivalent functions (COF) are identical functions.

4. The method according to claim 1 characterized in that the linking of the communication schedule to the use of the function (COF) and/or its multiple implementation in the star coupler is designed such that one or more of the following conditions apply:
a) at no time more Ethernet messages or parts of these Ethernet messages are to be delivered to the function (COF) or already be processed by the function (COF) than the function (COF) is able to process simultaneously;
b) the times for transmission and/or the times for forwarding and/or the times for receiving Ethernet messages, which can be defined in the communication schedule, are chosen such that the time period from the arrival of a time-controlled Ethernet message in a star coupler to its processing by the function (COF) does not exceed a given duration;
c) the times for transmission and/or the times for forwarding and/or the times for receiving Ethernet messages, which can be defined in the communication schedule, are chosen such that the time period from the arrival of a time-controlled Ethernet message in a star coupler to its processing by the function (COF) does not fall below a given duration.

5. The method according to claim 1 characterized in that a star coupler implements, in addition to the number of functionally equivalent, in particular identical functions (COF), in particular functionally equivalent CPU-intensive, for example identical CPU-intensive functions (COF), which are used for time-controlled Ethernet messages or parts of the Ethernet messages, also one, two or multiple of these functions (COF), which can be used by non-time-controlled Ethernet messages.

6. The method according to claim 1 characterized in that the at least one or two or multiple function(s) (COF) are a function or functions that encrypt the content of at least part of the time-controlled Ethernet messages being used as input parameters, using a cryptographic algorithm.

7. The method according to claim 1 characterized in that the at least one or two or multiple function(s) (COF) are a function or functions that decrypt the content of at least part of the time-controlled Ethernet messages using a cryptographic algorithm.

8. The method according to claim 1 characterized in that the at least one or two or multiple functions (COF) are a function or functions which package the content of one, two or multiple time-controlled Ethernet messages into one, two or multiple new Ethernet messages, where preferably the new Ethernet messages are not identical to the original Ethernet messages.

9. The method according to claim 1 characterized in that in a star coupler the forwarding actions from/to the function (COF) or its multiple implementations and/or the processing of the Ethernet messages or parts of the Ethernet messages in the function (COF) is activated when the common time basis has reached predefined values.

10. The method according to claim 1 characterized in that the one or two or multiple Ethernet messages generated by the function (COF) are not identical to the one or multiple Ethernet messages which are used as input parameter(s) for generating this at least one generated Ethernet message.

11. A computer network for the transmission of messages, wherein the computer network comprises computing nodes with said computing nodes being interconnected by means of at least one star coupler and/or at least one multi-hop network, wherein each computing node is connected to the at least one star coupler via at least one communication line, and wherein the computing nodes exchange Ethernet messages among each other and with the at least one star coupler and/or the at least one multi-hop network,
characterized in that
a) at least a portion, e.g. one, two, multiple or all, of the Ethernet messages are communicated in a time-controlled manner, and
b) at least one star coupler-implements at least one function (COF), with the at least one function (COF) being characterized in that it uses one, two or multiple time-controlled Ethernet messages and/or parts of one, two or multiple Ethernet messages as input parameter(s), and that it generates as output one, two or more Ethernet messages and/or parts of one, two or multiple Ethernet messages, and
c) for at least a part, e.g. for one, two, multiple or all, of the time-controlled communicated Ethernet messages the time use of the function (COF) and/or its multiple implementation in the star coupler is linked to the communication schedule of the time-controlled messages, so that the time use of the function (COF) and/or its multiple implementation is, at least partially, determined by the communication schedule of the time-controlled messages.

12. Computer network according to claim 11 characterized in that a star coupler implements a number of functionally equivalent functions (COF) with said number being less than the number of the components to which the star coupler can be directly connected simultaneously.

13. The computer network according to claim 12 characterized in that functionally equivalent functions (COF) are identical functions.

14. Computer network according to claim 1 characterized in that the linking of the communication schedule to the utilization of the function (COF) and/or its multiple implementation in the star coupler-is designed such that one or multiple of the following conditions apply:
a) at no time more Ethernet messages or parts of these Ethernet messages are to be delivered to the function (COF) or be already processed by the function (COF) than the function is able to process simultaneously;
b) the times for transmission and/or the times for forwarding and/or the times for receiving Ethernet messages, which can be defined in the communication schedule, are chosen such that the time period from the arrival of a time-controlled Ethernet message in a star coupler—to its processing—by the function (COF) does not exceed a given duration;
c) the times for transmission and/or the times for forwarding and/or the times for receiving Ethernet messages, which can be defined in the communication schedule, are chosen such that the time period from the arrival of a time-controlled Ethernet message in a star coupler to its processing by the function (COF) does not fall below a given duration.

15. The computer network according to claim 11, characterized in that a star coupler implements, in addition to the number of functionally equivalent, in particular identical functions (COF), in particular functionally equivalent CPU-intensive functions like identical CPU-intensive functions (COF) for example, which are used for time-controlled Ethernet messages or portions of Ethernet messages, also one, two or multiple of these functions (COF), which can be used by non-time-controlled Ethernet messages.

16. The computer network according to claim 1 characterized in that the at least one or two or multiple function(s) (COF) are a function or functions that encrypt the content of at least part of the time-controlled Ethernet messages being used as input parameters, using a cryptographic algorithm.

17. The computer network according to claim 11 characterized in that the at least one or two or multiple function(s) (COF) are a function or functions that decrypt the content of at least part of the time-controlled Ethernet messages using a cryptographic algorithm.

18. The computer network according to claim 11 characterized in that the at least one or two or multiple functions (COF) are a function or functions which package the content of one, two or multiple time-controlled Ethernet messages into one, two or multiple new Ethernet messages, with preferably the new Ethernet messages being not identical to the original Ethernet messages.

19. The computer network according to claim 11 characterized in that in a star coupler, the forwarding actions from/to the function (COF) or its multiple implementations and/or the processing of the Ethernet messages or parts of the Ethernet messages in the function (COF) is activated when the common time basis has reached predefined values.

20. The computer network according to claim 11 characterized in that the one or two or multiple Ethernet messages generated by the function (COF) are not identical to the one or the multiple Ethernet messages being used as input parameters for the generation of this at least one generated Ethernet message.
